(19) United States
(12) Patent Application Publication
(10) Pub. No.: US 2023/0125875 A1
(43) Pub. Date: Apr. 27, 2023

(54) COMPOSITIONS COMPRISING SILICONE, ARTICLES, DEVICES, AND METHOD OF MAKING THEREOF

(71) Applicant: Momentive Performance Materials Inc., Waterford, NY (US)

(72) Inventors: Kartick BINDUMADHAVAN, Bangalore (IN); Monjit PHUKAN, West Harrison, NY (US); Cheng DIAO, White Plains, NY (US); Shreedhar BHAT, Bangalore (IN)

(21) Appl. No.: 17/908,721

(22) PCT Filed: Mar. 5, 2021
(86) PCT No.: PCT/US2021/021025

§ 371 Date: Sep. 1, 2022

(30) Foreign Application Priority Data
Mar. 6, 2020 (IN) 202021009736

(51) Int. Cl. H01M 50/403; H01M 50/417; H01M 50/457; H01M 50/491; H01M 50/494

(52) U.S. Cl. CPC H01M 50/403; H01M 50/417; H01M 50/457; H01M 50/491; H01M 50/494

(57) ABSTRACT

A composition comprising at least one thermoplastic resin and a silicone-masterbatch, articles comprising the compositions, devices comprising the articles, and processes for preparing the article. The compositions are suitable for use as part of or as a separator material for use in an electrochemical device. The composition is used to prepare a film, a membrane, a matrix, a resin, a coating, or a paint, etc., which can be employed as a separator or to coat or form part of a layer of a separator material useful in a device such as an electrical storage device such as, for example, a battery, a fuel cell, a capacitor, etc.

### CROSS-REFERENCE TO RELATED APPLICATIONS

The present application claims priority to and the benefit of India Patent Registration Provisional Application 202021009736 filed on Mar. 6, 2020, the disclosure of which is incorporated herein by reference in its entirety.

### FIELD OF INVENTION

The present invention provides electrochemical film compositions, an electrochemical separator comprising the film, devices comprising separator, processes for preparing the compositions, and processes for preparing electrochemical film utilizing the compositions. In particular, the present invention provides compositions comprising a thermoplastic resin and a silicone master batch, processes for preparing the compositions, an electrochemical film prepared using such compositions, methods of making such film, an electrochemical separator comprising such film and a device comprising the separator, e.g., an electrochemical device

### BACKGROUND

With the continued advancement of electronic equipment and the development of products using alternative fuel sources, e.g., electric vehicles, there is an interest in developing more robust energy storage devices, e.g., batteries, capacitors, fuel-cells etc., to meet the demands of these advancing technologies. In the case of energy devices, such as, e.g., batteries, electrical energy is derived from chemical reactions occurring between the two electrodes, wherein the ions and molecules pass through the electrolyte and undergo redox reactions generating power. In these energy storage devices, the electrodes, namely the negative and positive electrodes, are typically separated from each other by an electrically insulating and porous membrane. This membrane is usually referred to as a separator. The separator functions to maintain the flux of electrolyte and ions across the two electrodes while also protecting the electrodes from direct electrical contact with one another to avoid or reduce the occurrence of short circuits. Advancements or improvements in the electrodes, electrolyte, and other materials utilized to provide high voltage batteries also require separator materials that can match the chemical, physical, and electrical properties to provide safe and reliable batteries to be used in a wide range of application. Conventional separators are generally formed from polyolefin materials such as, for example, polypropylene, polyethylene, PMMA, PVDF, etc., as well as cellulose-based materials. These materials pose challenges with respect to their stability at high temperatures, fire retardance, wettability with electrolytes, electrolyte co-solvents and other ingredients. Some of the separators also exhibit high impedance, which deteriorates the performance of the energy storage device. In addition, these conventional classes of separators have also been noted to be unsuitable for high voltage battery application for various reasons such as, for example, high temperature melt integrity, wettability with solvents used for high voltage devices, poor performance with respect to one or more properties such as thermal stability, shrinkage, fire retardancy, and surface compatibility with anodic and cathodic materials. The conventional separators available today are generally formed by extrusion followed by coating with ceramic-based formulations. The ceramic coating tends to provide improved thermal stability but also may exhibit high impedance.

While there are reports of different polyolefin-based films for use as separators in electrical storage devices, many do not provide the properties needed to meet the demand for chemical, physical, and electrical efficiencies required to provide a reliable electrical storage device.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present invention generally provides, in one aspect, a composition suitable for preparing a film, a binder, an electrode, an electrolyte, a separator, or combinations thereof. The present invention provides, in one aspect, a composition suitable for preparing a film, e.g., an electrochemical film, which can be employed to provide an improved separator for use in an electrochemical device. The composition can be used as a coating for a separator or can be used as part of a composition to prepare the separator itself. The compositions can be employed in a separator to provide high voltage devices with improved properties in terms of stability, reliability, safety, and others.

In one aspect, provided is an electrochemical film composition comprising: (i) at least one thermoplastic resin, and (ii) a silicone-masterbatch, wherein the masterbatch comprises at least one silicone represented by formula (I):

MₐD_{b}T_{c}Q_{d}Rₑ (I)

where M is (R¹)(R²)(R³)SiZ_{1/2}

D is (R⁴)(R⁵)SiZ_{2/2}

T is (R⁶)SiZ_{3/2}

Q is SiZ_{4/2}

where R¹, R², R³, R⁴, R⁵, and R⁶ are each independently selected from a C1-C10 alkyl, a C1-C10 alkoxy, a C2-C10 alkenyl, a C6-C20 aryl, OH, and a halogen atom; R is —(CH₂)_{1/2}(R⁷)_{f}(CH₂)_{1/2} where R⁷ is a C1-C10 alkyl; Z is independently selected from O, N, or S; a, b, c, d, and e are 0 or a positive integer where a+b+c+d+e is from about 1 to about 50,000, and f is 0 or 1.

In one embodiment, the silicone is an MDTQ resin, a T resin, an MT resin, an MQ resin, or a combination of two or more thereof.

In one embodiment, the silicone is represented by formula (II):

MD_{b}M (II)

wherein M is (R¹)(R²)(R³)SiZ_{1/2} where R¹ and R² are each independently selected from a C1-C10 alkyl, and a C1-C10 alkoxy, and R³ is a C2-C10 alkenyl; D is (R⁴)(R⁵)SiZ_{2/2} where R⁴ and R⁵ are independently selected from a C1-C10 alkyl, and a C1-C10 alkoxy; Z is O; and b is about 100 to about 10,000.

In one embodiment, the thermoplastic resin is represented by formula (III):

[—C(R⁸)(R⁹)—C(R¹⁰)(R¹¹)—]_{z} (III)

where R⁸, R⁹, R¹⁰, and R¹¹ are each independently selected from H, a C1-C10 alkyl, a C1-C10 alkoxy, a C6-C20 aryl, and a halogen atom, and z is from about 10 to about 100,000. In one embodiment R⁸, R⁹, R¹⁰, R¹¹ are each H. In one embodiment, R⁸ and R¹⁰ are each H, and R⁹ and R¹¹ are each a C1-C10 alkyl.

In some embodiments, the thermoplastic resin comprises a polyolefin, a polycarbonate, polyethylene terephthalate (PET), or their copolymers thereof, polyvinylcarbonate (PVC), polysulfone, styrene acrylonitrile, polyamide, or combinations of two or more thereof. In one embodiment, the polyolefin is selected from polyethyelene, a polypropylene, a polybutylene, or a combination of two or more thereof.

In one or more embodiments, the thermoplastic resin is present in an amount of from about 1 wt. % to about 70 wt. %, and the silicone masterbatch is present in an amount of from about 1 wt. % to about 30 wt. % based on the total weight of the composition.

In one embodiment, the composition further comprises an auxiliary additive. The auxiliary additive may comprise an acrylate, a methacrylate, or a combination thereof. The auxiliary additive may further comprises at least one additive selected from the group consisting of a filler, a cross-linking agent, a pigment, a stabilizer, a dispersant, a wetting agent, a rheology modifier, a defoamer, a thickener, a biocide, a mildewcide, a colorant, and a co-solvent.

In one embodiment, the at least one additive is a cross-linking agent. The cross-linking agents may include, but are not limited to, silane coupling agents, amine coupling agents, or epoxy, mepcapto, isocyanate containing silane and silylated polyazamide.

In some embodiments, the composition further comprises one or more fillers.

In another aspect, provided is a film comprising the composition of any of the previous embodiments.

In one embodiment, the film is a porous film.

In one embodiment, the film has a porosity in a range from about 25% to about 50%.

In one embodiment, the film is a multilayered film comprising two or more layers where at least one of the layers comprises the electrochemical film composition. In one embodiment, the multilayered film comprises a core layer, a first layer disposed on a first surface of the core layer, and a second layer disposed on a second surface of the core layer.

In one embodiment, the electrochemical film has a dimensional stability of about 50% to about 100% when subjected to a heat treatment between 80-200° C. in air.

In one embodiment, the electrochemical film has a retention in dimensional stability in a range from about 84% to about 100%, when subjected to heat treatment at 200° C. for 3 minutes.

In one embodiment, the electrochemical film is resistant to dimensional loss at a heating rate of 80° C. for 4 hours or 150° C. for 10 minutes.

In one embodiment, the electrochemical film has a flammability in a range from about 0 to about 250 seconds as per UL94 standard.

In one embodiment, the electrochemical film has a water vapour transmission rate (WVTR) in a range from about 1 g/m²·day to about 200 g/m²·day.

In one embodiment, the electrochemical film has a tear strength in a range from about 200 mN to about 5000 mN in both machine and traverse directions.

In one embodiment, the electrochemical film has a tear strength in a range from about 2000 mN to about 4000 mN in both machine and traverse directions.

In still another aspect, provided is an electrochemical separator comprising the film of any of the previous embodiments.

In still a further aspect, provided is a method of making a film comprising:

(a) mixing the electrochemical film composition as described above with a base polymer and optionally one or more auxiliary additives resulting in a mixture,

(b) extruding the mixture to prepare a non-porous film; and

(c) stretching the non-porous film uniaxially or biaxially to allow developing a porosity in the range of from about 25% to about 50%.

In one embodiment, an electrochemical film prepared by the method as described above, wherein the film has a dimensional stability of about 50% to about 100% when subjected to a heat treatment between 80-200° C. in air.

In one embodiment, the electrochemical film prepared by the method as described above has a retention in dimensional stability in a range from about 84% to about 100%, when subjected to heat treatment at 200° C. for 3 minutes.

In one embodiment, the electrochemical film prepared by the method as described above is resistant to dimensional loss at a heating rate of 80° C. for 4 hours or 150° C. for 10 minutes.

In one embodiment, the electrochemical film has a flammability in a range from about 0 to about 250 seconds as per UL94 standard.

In one embodiment, the electrochemical film prepared by the method as described above has a water vapour transmission rate (WVTR) in a range from about 1 g/m²·day to about 200 g/m²·day.

In one embodiment, the electrochemical film prepared by the method as described above has a tear strength in a range from about 200 mN to about 5000 mN in both machine and traverse directions.

In one embodiment, the electrochemical film prepared by the method as described above has a tear strength in a range from about 2000 mN to about 4000 mN in both machine and traverse directions.

In yet another aspect, provided is an electrochemical separator comprising the above film.

In still yet another aspect, provided is an electrochemical device comprising the electrochemical film of any of the previous embodiments.

In one embodiment, the electrochemical device is functioning in a range from about 0.001V to about 5.4 V. In one embodiment, the electrochemical device operates in a range from about 0.01 V to about 3.0 V.

In one embodiment, the electrochemical device operates at current densities in a range from about 50 mA/g to about 5 A/g.

In one embodiment, the electrochemical device operates in a range from about 20 cycles to about 50 cycles at a current density of 100 mA/g.

In one embodiment, the electrochemical device operates in a range from about 25 cycles to about 40 cycles at a current density of 100 mA/g.

An electrochemical separator is prepared by a method comprising: (a) mixing the electrochemical film composition of claim 1 with a base polymer and optionally one or more auxiliary additives resulting in a mixture, (b) extruding the mixture to prepare a non-porous film; and (c) stretching the non-porous film uniaxially or biaxially to allow developing a porosity in the range of from about 25% to about 50%, wherein the film has a dimensional stability of about 50% to about 100% when subjected to a heat treatment between 80-200° C. in air.

The following description discloses various illustrative aspects. Some improvements and novel aspects may be expressly identified, while others may be apparent from the description.

### BRIEF DESCRIPTION OF THE DRAWINGS

FIG. 1 is a cyclic voltammogram of a half-cell constructed with a film in accordance with one of the present embodiments;

FIG. 2 is a cyclic voltammogram of a half-cell constructed with a film in accordance with one of the present embodiments;

FIG. 3 is a cyclic voltammogram of a half-cell constructed with a film in accordance with one of the present embodiments; and

FIG. 4 is a graph showing the cycling stability of a half-cell employing a separator comprising a film in accordance with one of the present embodiments.

### DETAILED DESCRIPTION

Reference will now be made to exemplary embodiments, examples of which are illustrated in the description. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

As used in the instant application, the term “alkyl” includes straight, branched, and cyclic alkyl groups. Specific and non-limiting examples of alkyls include, but are not limited to, methyl, ethyl, propyl, hexyl, octyl, and isobutyl. In embodiments, the alkyl group is chosen from a C1-C30 alkyl, a C1-C18 alkyl, a C2-C10 alkyl, even a C4-C6 alkyl. In embodiments, the alkyl is chosen from a C1-C6 alkyl.

As used herein, the term “aryl” refers to a non-limiting group of any aromatic hydrocarbon from which one hydrogen atom has been removed. An aryl may have one or more aromatic rings, which may be fused, or connected by single bonds or other groups. Specific and non-limiting examples of aryls include, but are not limited to, tolyl, xylyl, phenyl, and naphthalenyl. In embodiments, an aryl group may be chosen from a C6-C30 aryl, a C6-C20 aryl, even a C6-C10 aryl.

As used herein, the term “alkoxy” refers to a group of the formula —OR, where R is an alkyl group. In embodiments, the alkyl group is chosen from a C1-C30 alkyl, a C1-C18 alkyl, a C2-C10 alkyl, even a C4-C6 alkyl. In embodiments, the alkyl is chosen from a C1-C6 alkyl.

As used herein, the term “alkenyl” refers to any straight, branched, or cyclic alkenyl group containing one or more carbon-carbon double bonds, where the point of substitution can be either at a carbon-carbon double bond or elsewhere in the group. In embodiments, the alkenyl group is chosen from a C2-C10 alkenyl, a C3-C8 alkenyl, or a C4-C6-alkenyl. Some examples of alkenyls include, but are not limited to, vinyl, propenyl, allyl, methallyl, ethylidenyl norbornane, ethylidene norbornyl, ethylidenyl norbornene and ethylidene norbomenyl.

The term “silicone-masterbatch” refers to a mixture of silicone and thermoplastic resin. Advantageously, the silicone masterbatch used in the composition of the invention is a masterbatch commercially available as PEarlene.

The present invention provides a composition. The composition may be used as an electrochemical film composition. The composition may also be referred to herein as, and used interchangeably with, the term “electrochemical film composition.” Embodiments of the composition comprise a thermoplastic resin and a silicone-masterbatch. The composition may be provided as desired, and in certain embodiments is provided as a masterbatch that can employed to form a binder, an electrode, an electrolyte, a film, a separator or combinations thereof. Reference to the electrochemical film composition encompass such compositions that are mixtures of the thermoplastic resin and the silicone-masterbatch.

The embodiments of the present electrochemical film composition comprise (i) at least one thermoplastic resin, and (ii) a silicone-masterbatch comprising at least one silicone. The silicone may be provided in any suitable form including, but not limited to, a particle, a resin, an oligomer, a silicone containing gum, a silicone resin, or a combination of two or more thereof.

In one or more embodiments, the silicone may include an organosilicon, a siloxane, a silane, or a mixture of two or more thereof. It will be appreciated that the silicone can be provided as a mixture of two different silicones of a similar class of material. For example, the composition includes a mixture of two or more different siloxanes, two or more different silanes, two or more different siloxane and silanes, etc.

In one embodiment, the invention provides an electrochemical film composition comprising: (i) at least one thermoplastic resin, and (ii) a silicone-masterbatch, wherein the silicone-masterbatch comprises at least one silicone represented by formula (I):

MₐD_{b}T_{c}Q_{d}Rₑ (I)

where M is (R¹)(R²)(R³)SiZ_{1/2}

D is (R⁴)(R⁵)SiZ_{2/2}

T is (R⁶)SiZ_{3/2}

Q is SiZ_{4/2}

R¹, R², R³, R⁴, R⁵, and R⁶ are each independently selected from a C1-C10 alkyl, a C1-C10 alkoxy, a C2-C10 alkenyl, a C6-C20 aryl, OH, and a halogen atom; R is —(CH₂)_{1/2}(R⁷)_{f}(CH₂)_{1/2} where R⁷ is a C1-C10 alkyl; Z is independently selected from O, N, or S; a, b, c, d, and e are 0 or a positive integer where a+b+c+d+e is from about 1 to about 50,000, and f is 0 or 1.

In one embodiment the invention provides an electrochemical film composition comprising: (i) at least one thermoplastic resin, and (ii) a silicone-masterbatch, wherein the silicone-masterbatch comprises at least one silicone represented by formula (II):

MD_{b}M (II)

wherein M is (R¹)(R²)(R³)SiZ_{1/2} where R¹ and R² are each independently selected from a C1-C10 alkyl, and a C1-C10 alkoxy, and R³ is a C2-C10 alkenyl; D is (R⁴)(R⁵)SiZ_{2/2} where R⁴ and R⁵ are independently selected from a C1-C10 alkyl, and a C1-C10 alkoxy; Z is O; and b is about 100 to about 10,000.

In one embodiment, the invention provides an electrochemical film composition comprising: (i) at least one thermoplastic resin, and (ii) a silicone-masterbatch, wherein the thermoplastic resin is represented by the formula (III):

[—C(R⁸)(R⁹)—C(R¹⁰)(R¹¹)—]_{z} (III)

where R¹, R⁹, R¹⁰, and R¹¹ are each independently selected from H, a C1-C10 alkyl, a C1-C10 alkoxy, a C6-C20 aryl, and a halogen atom, and z is from about 10 to about 100,000.

In one embodiment, the invention provides an electrochemical film composition comprising: (i) at least one thermoplastic resin, and (ii) a silicone-masterbatch, wherein the thermoplastic resin is represented by the formula (III):

[—C(R⁸)(R⁹)—C(R¹⁰)(R¹¹)—]_{z} (III)

wherein R⁸, R⁹, R¹⁰, and R¹¹ are each H.

In one embodiment, the invention provides an electrochemical film composition comprising: (i) at least one thermoplastic resin, and (ii) a silicone-masterbatch, wherein the thermoplastic resin is represented by the formula (III):

[—C(R⁸)(R⁹)—C(R¹⁰)(R¹¹)—]_{z} (III)

wherein R⁸ and R¹⁰ are each H, and R⁹ and R¹¹ are each a C1-C10 alkyl.

In one embodiment, the invention provides an electrochemical film composition comprising: (i) at least one thermoplastic resin, and (ii) a silicone-masterbatch, wherein the thermoplastic resin comprises polyolefin, polycarbonate, polyethylene terephthalate (PET), or their copolymers thereof, polyvinylcarbonate (PVC), polysulfone, styrene acrylonitrile, polyamide, or combinations thereof.

In one embodiment, the invention provides an electrochemical film composition comprising: (i) at least one thermoplastic resin, and (ii) a silicone-masterbatch, wherein the thermoplastic resin is present in an amount of from about 1 wt. % to about 70 wt. %, and the silicone masterbatch is present in an amount of from about 1 wt. % to about 30 wt. % based on the total weight of the composition.

In one embodiment, the invention provides an electrochemical film composition comprising: (i) at least one thermoplastic resin, and (ii) a silicone-masterbatch, wherein the composition further comprises a component selected from the group consisting of an acrylate, a methacrylate, a filler, a cross-linking agent, a pigment, a stabilizer, a dispersant, a wetting agent, a rheology modifier, a defoamer, a thickener, a biocide, a mildewcide, a colorant, and a co-solvent.

In one embodiment, the invention provides an electrochemical film prepared from an electrochemical film composition comprising: (i) at least one thermoplastic resin, and (ii) a silicone-masterbatch.

In one embodiment, the invention provides an electrochemical film prepared from a composition comprising: (i) at least one thermoplastic resin, and (ii) a silicone-masterbatch, wherein the film has a porosity in the range from about 25% to about 50%.

In one embodiment, the invention provides an electrochemical film prepared from a composition comprising: (i) at least one thermoplastic resin, and (ii) a silicone-masterbatch, wherein the film is a multilayered film comprising two or more layers where at least one of the layers comprises the electrochemical film composition.

In one embodiment, the invention provides an electrochemical film prepared from a composition comprising: (i) at least one thermoplastic resin, and (ii) a silicone-masterbatch, wherein the multilayered film comprises a core layer, a first layer disposed on a first surface of the core layer, and a second layer disposed on a second surface of the core layer.

In one embodiment, the invention provides an electrochemical film prepared from a composition comprising: (i) at least one thermoplastic resin, and (ii) a silicone-masterbatch the film having a dimensional stability of about 50% to about 100% when subjected to a temperature in the range of 80-200° C. in air.

In one embodiment, the invention provides an electrochemical film prepared from a composition comprising: (i) at least one thermoplastic resin, and (ii) a silicone-masterbatch, wherein the film has a retention in dimensional stability in the range from about 84% to about 100%, when subjected to a temperature of 200° C. for 3 min.

In one embodiment, the invention provides an electrochemical film prepared from a composition comprising: (i) at least one thermoplastic resin, and (ii) a silicone-masterbatch, wherein the film is resistant to dimensional loss when heated at a temperature of 80° C. for 4 hours or at a temperature of 150° C. for 10 minutes.

In one embodiment, the invention provides an electrochemical film prepared from a composition comprising: (i) at least one thermoplastic resin, and (ii) a silicone-masterbatch, wherein the film has a flammability in the range from about 0 to about 250 seconds as per UL94 standard.

In one embodiment, the invention provides an electrochemical film prepared from a composition comprising: (i) at least one thermoplastic resin, and (ii) a silicone-masterbatch, wherein the film has a water vapour transmission rate (WVTR) in the range from about 1 g/m²·day to about 200 g/m²·day.

In one embodiment, the invention provides an electrochemical film prepared from a composition comprising: (i) at least one thermoplastic resin, and (ii) a silicone-masterbatch, wherein the film has a tear strength in the range from about 200 mN to about 5000 mN in both machine and traverse directions.

In one embodiment the invention provides an electrochemical separator comprising an electrochemical film as defined herein.

In one embodiment the invention provides an electrochemical device comprising the separator as defined herein.

In one embodiment the invention provides an electrochemical device comprising the separator as defined herein wherein, the electrochemical device operates in a voltage range from about 0.001V to about 5.4 V.

In one embodiment the invention provides an electrochemical device comprising the separator as defined herein wherein, the electrochemical device operates at current densities in the range from about 50 mA/g to about 5 A/g.

In one embodiment the invention provides an electrochemical device comprising the separator as defined herein wherein, wherein the electrochemical device operates for about 20 cycles to about 50 cycles at a current density of 100 mA/g.

In one embodiment the invention provides a method of preparing an electrochemical film, the method comprising:

(a) extruding a composition of any one of the claims 1 to 8 to prepare a non-porous film; and
(b) stretching the non-porous film uniaxially or biaxially to allow developing a porosity in the range of from about 25% to about 50%.

In one embodiment the invention provides an electrochemical film prepared by the method as defined herein, the film having a dimensional stability of about 50% to about 100% when heated at a temperature in the range of 80-200° C. in air

In one embodiment, the silicone is of the formula (I):

MₐD_{b}T_{c}Q_{d}Rₑ (I)

where M is (R¹)(R²)(R³)SiZ_{1/2}

D is (R⁴)(R⁵)SiZ_{2/2}

T is (R⁶)SiZ_{3/2}

Q is SiZ_{4/2}

R¹, R², R³, R⁴, R⁵, and R⁶ are each independently selected from a C1-C10 alkyl, a C1-C10 alkoxy, a C2-C10 alkenyl, a C6-C20 aryl, OH, and a halogen atom; R is —(CH₂)_{1/2}(R⁷)_{f}(CH₂)_{1/2} where R⁷ is a C1-C10 alkyl; Z is independently selected from O, N, or S; a, b, c, d, and e are 0 or a positive integer where a+b+c+d+e is from about 1 to about 50,000, and f is 0 or 1. In one embodiment, at least one of R³, R⁵, and R⁶ is a C2-C10 alkenyl. In embodiments, a+b+c+d+e is from about 10 to about 10,000, from about 25 to about 7,500, from about 50 to about 5,000, from about 100 to about 2,500, or from about 100 to about 1,000.

In one or more embodiments, the silicone may be any combination of the MDTQ units described above. In embodiments, the silicone is selected from a T resin (which may also be referred to as a polysilsesquioxane resin), an MT resin, an MQ resin, an MDTQ resin, or a combination thereof.

In one embodiment, the silicone is of the formula (II):

MD_{b}M (II)

where the M and D units are as described above, and b is from about 100 to about 10,000. In an embodiment of formula (II), M is (R¹)(R²)(R³)SiZ_{1/2} where R¹ and R² are each independently selected from a C1-C10 alkyl, and a C1-C10 alkoxy, and R³ is a C2-C10 alkenyl; D is (R⁴)(R⁵)SiZ_{2/2} where R⁴ and R⁵ are independently selected from a C1-C10 alkyl, and a C1-C10 alkoxy; Z is O; and b is about 100 to about 10,000. In one of the embodiments, the M is an alkyl or alkoxy vinyl silane, and b is about 1,000 to about 7,000, in another embodiment, b is greater than 7,000.

In one or more embodiments, the silicone-masterbatch composition comprises a silicone in an amount of from about 1 wt. % to about 99 wt. %; from about 5 wt. % to about 90 wt. %; from about 10 wt. % to about 80 wt. %, from about 15 wt. % to about 75 wt. %; from about 20 wt. % to about 60 wt. %; from about 25 wt. % to about 65 wt. %, from about 30 wt. % to about 60 wt. %, even from about 40 wt. % to about 50 wt. %, based on the total weight of the composition. Here as elsewhere in the specification and claims, numerical values may be combined to form new and non-specified ranges. In one or more embodiments, the silicone-based additives may be added to the polyolefin in the amount described above to form a masterbatch.

The thermoplastic resin material is not particularly limited and can be selected as desired for a particular purpose or intended end application. The thermoplastic resin may be a homopolymer, a copolymer comprising different polycarbonate or polyolefin units, or a copolymer comprising a polyolefin and another repeating unit. The thermoplastic resin may include functional groups as may be desired to promote reactions or interactions with the silicone.

In one embodiment, the thermoplastic resin is a compound comprising repeating units of the formula (III):

[—C(R⁸)(R⁹)—C(R¹⁰)(R¹¹)—]_{z} (III)

where R⁸, R⁹, R¹⁰, and R¹¹ are each independently selected from H, a C1-C10 alkyl, a C1-C10 alkoxy, a C6-C20 aryl, and a halogen atom, and z is from about 10 to about 100,000. The weight average molecular weight of polyolefin can be up to about 200,000 g/mol. Molecular weight may be determined by gel permeation chromatography (GPC). In one embodiment, R⁸, R⁹, R¹⁰, and R¹¹ are each H. In one embodiment, R⁸ and R¹⁰ are each H, and R⁹ and R¹¹ are each a C1-C10 alkyl and in further embodiments are a C1 alkyl or a C2 alkyl.

Non-limiting examples of the thermoplastic resin include polycarbonates (PC), polyethylenes (PE), polypropylenes (PP), poly(4-methyl-1-pentene) (PMP), polybutene-1 (PB-1), polyisobutylenes (PIB), thermoplastic elastomers (TPE), copolymers thereof, modifications thereof and combinations thereof. The PE comprise ultrahigh molecular weight polyethylene (UHMWPE), high density polyethylene (HDPE), medium density polyethylene (MDPE), low density polyethylene (LDPE), linear low density polyethylene (LLDPE), branched low density polyethylene (BLDPE), ultralow density polyethylene (ULDPE), and the like. The PP comprise ultrahigh molecular weight polypropylene (UHMWPP), isotactic polypropylene (iPP), syndiotactic polypropylene (sPP), β-nucleated polypropylene (β-PP), β-nucleated ultrahigh molecular weight polypropylene (β-UHMWPP), high-crystalline polypropylene (HCPP), high melt-strength polypropylene (HMS-PP), mini-random PP (mr-PP), and the like, or combinations of two or more thereof.

The thermoplastic resin may also be selected from, but not limited to, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), a polyamide (e.g., polyamide 6, polyamide 6,6), polyamide-imide (PAI), polyaryletherketone (PAEK), polybutadiene (PBD), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyvinylcarbonate, (PC), polyhydroxybutyrate (PHB), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN) or combinations of two or more thereof.

In one embodiment, the thermoplastic resin is selected from a polyolefin material. In embodiments for the composition, wherein the composition is a masterbatch, the polyolefin is selected from polyethylene, a polyproplyene, a polybutylene, or a combination of two or more thereof. In one embodiment, the polyolefin is polyethyelene. In one embodiment, the polyolefin is polypropylene. In one embodiment, the polyolefin, is a copolymer of polyethylene and polypropylene.

In one embodiment, the thermoplastic resin varies in density from about 0.8 to about 0.95 g/cc. In one embodiment, the polyolefin varies in melt flow index from about 3 to about 30, from about 5 to about 25, from about 8 to about 20, or from about 10 to about 15. In one embodiment, the polyolefin has a melt flow index of from about 6 to about 11.

In one embodiment, the electrochemical film composition comprises the thermoplastic resin in an amount of from about 1 wt. % to about 99 wt. %; from about 5 wt. % to about 90 wt. %; from about 10 wt. % to about 80 wt. %, from about 15 wt. % to about 75 wt. %; from about 20 wt. % to about 60 wt. %; from about 25 wt. % to about 65 wt. %, from about 30 wt. % to about 60 wt. %, even from about 40 wt. % to about 50 wt. %, based on the total weight of the composition. In one embodiment, the electrochemical film composition comprises the thermoplastic resin in an amount of from about 1 wt. % to about 70 wt. %, from about 5 wt. % to about 60 wt. % from about 10 wt. % to about 50 wt. %, from about 15 wt. % to about 40 wt. % or from about 20 wt. % to about 30 wt. %; and the silicone-masterbatch is present in an amount of from about 1 wt. to about 30 wt. %, from about 5 wt. % to about 25 wt. %, or from about 10 wt. % to about 20 wt. %. Here as elsewhere in the specification and claims, numerical values can be combined to form new and non-specified ranges.

The electrochemical film compositions may include other materials as may be desired for a particular purpose or intended application. In one embodiment, the composition comprises co-monomers chosen from acrylates, methacrylates, alkyl acrylates, alkyl methacrylates, or a combination of two or more thereof. Examples of such comonomers include, but are not limited to, methyl acrylate, ethyl acrylate, ethyl methacrylate, butyl acrylate, 2-ethylhexyl acrylate, decyl acrylate, lauryl acrylate, methyl methacrylate, butyl methacrylate, isodecyl methacrylate, lauryl methacrylate, and the like.

In one or more embodiments, the composition further comprises auxiliary additives. The auxiliary additives may be used for making the non-porous film from composition. Examples of suitable additives include, but are not limited to, fillers, cross-linking agents, pigments, stabilizers, dispersants, wetting agents, rheology modifiers, defoamers, thickeners, biocides, mildewcides, colorants, pigments waxes, and co-solvents. The auxiliary additives may be mixed with base polyolefin and masterbatch composition during the film formation process.

In some embodiments, the composition further comprises one or more fillers. In one or more embodiments, the filler may include a ceramic material selected from, but is not limited to, BN, TiO₂, SiO₂, ZnO₂, modified SiO₂, e.g., alkyl modified SiO₂, aryl modified SiO₂, etc. The fillers may also include but are not limited to liquid silicone rubber, or silicone resin. In an exemplary embodiment, the liquid silicone rubber is Silopren™ liquid silicone rubber (available from Momentive Performance Materials). In an exemplary embodiment, the spherical silicone resin is Tospearl™ microspheres (available from Momentive Performance Materials), wherein the resin is available in 2.0, 3.0, 4.5- and 6.0-micron particle sizes.

In some embodiments, the composition further comprises a rheology modifier. The rheology modifiers are used to modify the rheological characteristics of the molding compound, for example, it may improve its lubricity and may reduce friction. Non limiting examples of rheology modifiers include copolymers of acrylic acid, N-vinylpyrrolidone, polyethylene glycol, calcium carbonate, ester terminated polyamide, spherical silicone resin (such as Tospearl™ microspheres), MQ resins, or MT resins, or a combination of two or more thereof. For example, rheology modifiers used in PEarlene™ silicone masterbatches helps to increase fabrication efficiency. The master batches typically enable higher extrusion throughput. PEarlene® silicone masterbatches can also increase the effective dispersion of additives when the loading levels are high.

In one embodiment, the composition further comprises at least one additive, wherein the additive is a cross-linking agent. In some embodiments, the cross-linking agents may include a silicone-based crosslinking agent. In one embodiment, the silicone-based crosslinking agent may include a silicone rubber or a vinyl silane. The cross-linking agents may include but is not limited to silane coupling agents, amine coupling agents, or epoxy, mepcapto, isocyanate containing silane, silylated polyazamide. For example, the silane coupling agents may include Silcat™, Silox™, Silquest™, XL-Pearl™ (from Momentive Performance Materials). An example of silylated polyazamide is Silquest™ Y-19139 (Momentive Performance Materials). Further examples of suitable silicone-based crosslinking agents include, but are not limited to, Silcat™ R silane (vinylsilane with grafting and crosslinking catalysts), Silcat™ RHE silane (crosslinking system of silane, peroxide and catalyst), Silcat™ RHS silane (crosslinking system of silane, peroxide catalyst and antioxidants), Silcat™ VS-735/1 silane (crosslinking system of silane, peroxide, antioxidants and metal deactivator), Silcat™ VS-758/0 silane (stabilized crosslinking system of silane, peroxide and catalyst), Silcat™ VS-870 silane (stabilized crosslinking system of silane, peroxide, catalyst, antioxidants and metal deactivator), Silcat™ VS-928 silane (stabilized crosslinking system of silane, peroxide, catalyst, antioxidants and metal deactivator), Silcat™ VS-963 silane (stabilized crosslinking system of silane, peroxide, catalyst, antioxidants and metal deactivator), Silox™ VS-911 silane (liquid silane system), silicone microspheres (e.g., silsesquioxane beads) sold under the tradename TOSPEARL™ from Momentive Performance Materials including, but not limited to, TOSPEARL™ 103, TOSPEARL™ 105, TOSPEARL™ 108, TOSPEARL™ 120, TOSPEARL™ 130, TOSPEARL™ 145, TOSPEARL™ 290, TOSPEARL™ 1100 TOSPEARL™ 2000B, TOSPEARL™ 3120 and TOSPEARL™ 240, etc., ionic siloxane polymers with carboxylic functionality sold under the tradename SilForm™ available from Momentive Performance Materials; and phenylpropyldimethylsiloxsysilicate materials sold under the name SilShine™ available from Momentive Performance Materials.

In one or more embodiments, the electrochemical film composition is provided as a masterbatch composition, wherein the masterbatch includes a thermoplastic resin and a silicone, as discussed herein. It will be appreciated that the masterbatch is provided with a thermoplastic resin and a silicone in accordance with the foregoing description of the composition. The terms “masterbatch composition” and “masterbatch” are used hereinafter interchangeably.

The term “masterbatch” generally refers to a solid or liquid concentrated mixture of additives encapsulated into a carrier resin. The masterbatch approach provides a more convenient way of incorporating the additives into the final articles. The term “masterbatch” also includes such composites and powders, granules, or particles formed from such composites and which may also be referred to herein as “masterbatch composites,” “masterbatch powders,” or the like. Generally, the masterbatch is blended using various techniques, with a base polymer material to form a final article of desired sizes and dimensions, wherein the concentration of the additives is diluted in the final article.

In one or more embodiments, the compositions may be used for forming a film, a membrane, a matrix, a resin, a coating, or a paint. In one or more embodiments, the composition is used in film forming operations, e.g., in an extrusion process, with a base polymer to form a polymeric film.

In one or more embodiments, the film may be non-porous or porous. In one or more embodiments, the film is processed to provide a porous film. In one embodiment, the film has a porosity of from about 25% to about 50%, from about 30% to about 45%, or from about 35% to about 40%. In some embodiments, the film has a porosity in a range from about 25% to about 50%. Generally, a more uniform porosity is desirable for improved performance of battery separators. The pore size of the film can also be selected as desired. In embodiments, the pore size of the film is less than 1 micron. The porous film may be used as membranes in an electrochemical device including, but not limited to, an energy generation device, an energy storage device, etc.

In one or more embodiments, the film is a multilayered film. The multilayer film may comprise two or more layers where at least one of the layers comprises the electrochemical film composition. In some embodiments, the multilayered film comprises a core layer, a first layer disposed on a first surface of the core layer, and a second layer disposed on a second surface of the core layer.

In some embodiments, the porous film may be used as membranes in an electrochemical device including, but not limited to, an energy generation device, an energy storage device, etc. In some embodiments, the membrane generated by extrusion of the film may be used as a separator in an electrochemical device. In some other embodiments, the film is used as a coating for a separator membrane in an electrochemical device.

In some embodiments, the compositions, and particularly in embodiments of the silicone-masterbatch compositions, may include PEarlene™ functional masterbatches, which contain substantial levels of ultra-high molecular weight polysiloxanes. Examples of such masterbatches include, but are not limited to, PEarlene Si PP MB-01™, PEarlene SiPP MB-02™, PEarlene Si PE MB-01™, PEarlene Si PE MB-02™, PEarlene Si PC MB-01™ available from Momentive Performance Materials. In one or more embodiments, the ultra-high molecular weight polysiloxanes may include silicone gums or silicone resins. The polysiloxanes may be melt-compounded into a variety of suitable polymer carriers. The polysiloxane dispersed in the polymer carrier are typically stable and easy to handle. The masterbatch compositions including PEarlene™ silicone includes formulations applicable to polypropylene (PP), ethyl methacrylate (EMA) and polyethylene (PE) carriers.

The method of making an article comprising a masterbatch composition, for example, a porous film may include the following operations:
Mixing the thermoplastic resin and the siloxane, optionally in the presence of an initiator, for the first extrusion process to form a masterbatch composition.
Mixing the masterbatch composition with a base polymer and one or more auxiliary additives for the second extrusion to form a non-porous film.
Stretching the non-porous film by uniaxial or biaxial stretching to form a porous film.
   In some embodiments, the porous film is used as a separator in an electrochemical device.

As noted, in one of the embodiments, the thermoplastic resin and the silicone are mixed together for the first extrusion process to form a masterbatch composition. This step may further comprise an initiator. The initiators may include, but is not limited to, free radical initiator, cationic initiator, anionic initiator, or combinations of two or more thereof. The silicone may be mixed with the initiator to cross-link, blend, or copolymerize with a thermoplastic resin to form a masterbatch. The initiator can be added from about 0.1 to about 5 wt. % with respect to the silicon.

The silicone can be incorporated into the resin material in any suitable manner. Generally, the compositions can be formed by mixing the silicone into the resin material. Mixing is desirably carried out to sufficiently disperse the silicone in the thermoplastic resin. Mixing can be carried out under conditions such that the shear forces are sufficient to disperse the silicone into the molten resin. Mixing can be accomplished by any type of mixing equipment or device suitable for mixing resin materials. Examples of suitable mixing equipment includes, but are not limited to, Brabender mixers, Banbury mixers, a roll, a kneader, a single screw extruder, a twin-screw extruder, a planetary roller extruder, etc.

The masterbatch composition is formed into a suitable form (e.g., a sheet), but is not limited to, by extrusion, molding, casting, etc. The resulting masterbatch composite form may then be granulated to provide a masterbatch powder material that is a composite powder of the silicone and the thermoplastic resin. The masterbatch form can be granulated or ground into powder particles by any suitable method including, but not limited to, hammer milling, jet milling, ball milling, vertical roller milling, vibration milling, classifier mills, sieving mills, cutting mills, etc.

The powders can be formed by any suitable technique including, but not limited to, grinding, milling, etc. using any suitable technique. In one embodiment, the grinding operation can be carried out using a suitable processing agent to prevent agglomeration of the particles during grinding. In still another embodiment, the particles can be produced by grinding or milling in the presence of another suitable material to affect the resin material in a desired manner.

In one embodiment, the masterbatch composition can be made in continuous or batch operations. The extruder for mixing the masterbatch can be a single screw extruder, a co-rotating or counter-rotating twin screw extruder, a multiple screw extruder, or a co-kneader. During melt mixing in an extruder under a continuous process, the polyolefin carrier is melted at an elevated temperature and mixed with fluidic ingredients. The extruder speeds can range from about 50 to about 500 revolutions per minute (rpm), and the processing conditions is performed at a temperature sufficient to melt the respective components. The pellets or beads which are obtained may be cut under water in standard size, which are used later for extrusion or molding into final articles. In twin screw extruder with gravimetric dosing units, proper mixing of ingredients is ensured. The main polymer carrier is added through a main hopper while the additives could be added either via the main hopper or a side feeder.

In one or more embodiments, the present technology also includes an article comprising a base polymer comprising a polyolefin and the present electrochemical film compositions, in more specific embodiments, the electrochemical film composition is provided as a masterbatch composition. In one or more embodiments, the article includes a film. The film may be a non-porous film or a porous film.

The electrochemical film compositions are employed to form a film by a suitable film forming method. In one embodiment, the electrochemical film compositions are provided as a masterbatch and mixed with a base polymer material and extruded to form a film. In this embodiment, one or more auxiliary additives may also be added to the electrochemical film composition and base polymer for extrusion of the film. The film produced after extrusion, or casting can be non-porous or porous. In non-limiting embodiments, the thickness of the film may vary from about 5 to about 45 micron. The produced film can be stretched uniaxially or biaxially to develop pores in the film.

When the electrochemical film composition is provided as a masterbatch, the masterbatch may be employed in an amount of from about 1 wt. % to about 50 wt. %, from about 5 wt. % to about 40 wt. %, from about 10 wt. % to about 30 wt. %, or from about 15 wt. % to about 25 wt. % based on the total weight of the composition for forming the film.

The base polymer material for forming the film is selected from a thermoplastic resin material. The thermoplastic resins materials suitable for use as the base polymer material for the film-forming compositions are the same as the thermoplastic resin materials described with respect to the thermoplastic resin used to form the masterbatch. For the sake of brevity, the list and discussion of those materials are not repeated in this section, but the list and discussion of those materials are incorporated herein by reference in their entirety.

In one or more embodiments, the base polymer material may be the same or different from the thermoplastic resin employed in the masterbatch. In one embodiment, the base polymer material for forming the film is the same as the thermoplastic resin employed in the masterbatch. In one embodiment, the base polymer material is a polycarbonate.

In one embodiment, the film is provided by adding the masterbatch to the base polymer material along with any other additives as may be desired and extruding that mixture to form a film. The film from this extrusion step is a non-porous film. The film obtained from this step is then subjected to stretching of the film to produce a porous film. Stretching may be done (i) uniaxially (e.g., in either the machine direction (MD) or the transverse direction (TD)); or (ii) biaxially in both the machine direction and the transverse direction.

The base polymer material and the masterbatch can be processed to form a film by any suitable method. The materials may be pre-blended in groups or all together, and then fed into the extruder with one or more feeders. The raw materials may preferably be metered into the extruders, each separately and without pre-blending. Solid feedstocks may be metered into the extruders via a main feeder, and liquid feedstocks can be pre-heated and then injected downstream via one or more additional downstream feeders.

The ratio of masterbatch material and base polymer material may be selected as desired for a particular purpose or intended application. The ratio may depend on the chemical makeup of the masterbatch material and the desired amount of silicon to introduce into the resin material being produced.

The materials fed to the extruder are dissolved at elevated temperatures and mixed homogeneously within the extruder. The homogeneous melt is then conveyed to a film-forming die through a multilayer feed block, to form a multilayer extrudate. Extrusion conditions are set in a way of ensuring a homogeneous mixing of the fed materials, while not to cause excessive degradation of any component. A monolithic or monolayer extrudate can be produced with a single extruder or by coextruding the same composition with multiple extruders. A multilayer structure is constructed through coextrusion or coextrusion plus in-line coating. The in-line coating may be carried out by any convenient method known in the art, such as roll coating, gravure coating, die coating, extrusion coating and the like. Alternatively, the layer-forming compositions may be first compounded into masterbatches, which are then re-extruded to form a multilayer coextrudate.

The extruders may be a single or multiple screw extruder having multiple feed ports downstream along the machine. In one embodiment, the extruder is a twin screw extruder. The twin screws may rotate in a co- or counter-direction, and preferably have a series of intense mixing and kneading sections. The coextrusion process may employ a tandem extruder, consisting of single and/or twin-screw extruders. Preferably, the coextrusion process yields a homogeneously mixed melt within a short residence time at a high output rate.

The extrudate exiting from the film-forming die is cast onto a cast roll to form a sheet. The cast roll temperature is set at a temperature to sufficiently cool or solidify the extrudate. For rapid quenching or coagulation, the casting process may employ an air knife, a water bath, a series of rolls, any additional cooling means, or combinations thereof. The design of the quenching system may depend on compositions of the extrudate, process conditions, and target profiles. A sufficiently low roll temperature can produce an asymmetrically structured film, i.e., a denser roll-side skin than the opposite air-side skin. A high roll temperature, on the other hand, may result in a reversed structure, i.e., a denser air-side skin than the roll-side surface.

It will be appreciated that the films can be a single layer film or a multi-layer film as desired for a particular purpose or intended application. In one embodiment, the film formed by the present materials and processes is a single layer film formed from a mixture of the masterbatch material and a base polymer material. In another embodiment, the film is a multi-layer film comprising 2 or more layers where at least one of the layers is formed from a mixture of the masterbatch composition and a base polymer material. In one embodiment, the film is a multi-layer film comprising a core layer consisting essentially of a base polymer material, a first skin layer disposed on a first surface of the core layer, and a second skin layer disposed on a second surface of the core layer (opposite the first surface), where at least one of the first skin layer, the second skin layer, or both the first skin layer and the second skin layer is formed from a composition formed from a mixture of a masterbatch composition and a base polymer material. It will be appreciated that the skin layers can have the same composition as each other (e.g., formed from the same masterbatch composition and base polymer material), or the skin layers can have different compositions that differ from one another with respect to the masterbatch composition employed, the base polymer material, or both the masterbatch and the polyolefin base material.

The film is passed to a section where it is stretched in the machine direction, the transverse direction, or both.

The film can be provided with dimensions as selected for a particular purpose or intended application. The films in accordance with the present technology are generally provided for use as a separator material in an electrochemical device. The present films generally possess one or more properties suitable for use in an electrochemical device and which may exhibit an improvement as compared to conventional separator films.

In one embodiment, the film has a thickness of about 25 micron or less. In one embodiment, the film has a thickness of from about 1 to about 25 micron, from about 2 to about 15 micron, or from about 10 to about 15 micron. Thickness can be evaluated using any suitable method including, for example, ASTM D5947-96. Standard Test Methods for Physical Dimensions of Solid Plastics Specimens (ASTM International), or ASTM D2103, Standard Specification for Polyethylene Film and Sheeting (ASTM International).

In one embodiment, the film has a shrinkage of from about 0.5% to about 10% in the machine direction, from about 1% to about 7.5% in the machine direction, or from about 2% to about 5% in the transverse direction. In one embodiment, the film has a shrinkage of from about 0.5% to about 10% in the transverse direction, from about 1% to about 7.5% in the transverse direction, or from about 2% to about 5% in the transverse direction. In one embodiment, the film has a shrinkage of 5% or less in both the machine direction and the transverse direction. Shrinkage can be evaluated by ASTM D1204, Standard Test methods for Linear Dimensional Changes of Nonrigid Thermoplastic Sheeting or Film at Elevated Temperatures (ASTM International).

Gurley Number: The Gurley second or Gurley unit indicates the air permeability or porosity as a function of the time, wherein a specific amount of air is passed through a specific area of a separator under a specified pressure. Conventionally, the ISO 5636-5:2003 standard requires 1 deciliter of air to be passed through 1.0 square inch of a given material at 0.176 psi, and test standard ASTM-D 726 (B) is recommended.

Wettability: The separators should wet out quickly and completely in typical battery electrolytes. The contact angle measurement is widely used to determine the wettability of the film surface towards an electrolyte solvent.

Skew Strength: The skew strength is related with the ability of the separator to lay flat without any presence of bow or skew. In the case of extreme skew conditions, the separator may misalign between electrodes causing failure of the battery. Generally, skew is measured by laying the separator flat on a surface against a straight meter stick. The acceptable skew deviation is less than 0.2 mm/m of separator.

Puncture Strength: A separator film is required to possess sufficient physical strength to withstand the abuse during cell fabrication and repeated cycling of battery. The puncture strength is a measure of weight is necessary to pierce through the surface of separator creating a puncture. The puncture strength of the film is greatly influenced by the materials used for development of the film as well as the manufacturing method. The biaxially stretched films demonstrate high puncture strengths due to their high tensile strength and rupture strength in both the directions. Puncture strength should generally be about 300 g/mil or greater. Puncture strength can be measured using ASTM D3763, Standard Test Method for High-Speed Puncture Properties of Plastics using Load and Displacement Sensors (ASTM International).

Chemical stability: The separators should be stable towards electrolytes and other electrochemical fluids which are added during the fabrication of battery and also must be stable towards the electrochemical environment during the cycling of the battery over its lifespan of use. The separators should not get oxidized or reduced and loose their mechanical properties. In addition, due to side reactions they should also not produce any impurities. The separators should be able to withstand electrochemical activity at elevated temperature up to 75° C. The polyolefins such as polypropylene and polyethylene are capable of withstanding oxidation and the electrochemical environment in a lithium ion cell.

High temperature stability: The separators are expected to provide safety by insulating the direct contact between two electrodes at high temperature. Separators with high mechanical integrity at elevated temperature can provide higher safety. The mechanical integrity is measured by thermal mechanical analysis, wherein the film is held under contact load and the elongation is measured against temperature.

Melt integrity: The separators used in battery should have high temperature melt integrity, wherein, after shutdown the electrodes should not come in direct contact with each other. This restricts the thermal runaway conditions at elevated temperatures. Conventionally this property is assessed from thermal mechanical analysis (TMA) of separator films. In embodiments, the film has a melt integrity of about 150° C. or greater.

The porous films can be employed in an electrochemical device such as an electrical storage device. In embodiments, the porous films can be used as a separator, for example, for secondary batteries such as a nickel-hydrogen battery, a nickel-cadmium battery, a nickel-zinc battery, a silver-zinc battery, a lithium secondary battery, and a lithium polymer secondary battery, plastic film capacitors, ceramic capacitors, and electric double layer capacitors. The electrical storage devices can be rechargeable devices.

In one embodiment, the films and/or a separator comprising the present films may exhibit a dimensional stability of from about 50% to about 100% when subjected to a heat treatment between 80 to about 200° C. in air. In embodiments, dimensional stability is from about 60% to 100%, about 75% to about 100%, about 85% to about 100%, or from about 95% to about 100%. Dimensional stability can be evaluated by cutting a sample of the separator into rectangular shape, measuring the size before placing in an oven, and measuring the size/dimensions of the material after exposure to heat. In embodiments, the separator is resistant to dimensional loss at a heating rate of 80° C. for 4 h or 150° C. for 10 min.

In one embodiment, the films or a separator comprising the present films has a flammability of from about 0 to about 250 seconds. Flammability can be evaluated on a Horizontal Vertical Flame Chamber, ATLAS, HVUL-2, USA under the test standard of UL-94.

In one embodiment, the films or a separator comprising the present films have a water vapor transmission rate (WVTR) of from about 1 g/m²·day to about 200 g/m²·day. WVTR can be measured on a Water Vapor permeability Tester, LYSSY, L80-5000, Switzerland following the standard of ASTM E96.

In one embodiment, the present films or a separator comprising the present films has a tear strength in the machine direction, the transverse direction, or both the machine and the transverse direction of from about 200 mN to about 5000 mN, from about 500 mN to about 4500 mN, from about 750 mN to about 4000 mN, from about 1000 mN to about 3000 mN, or from about 1500 mN to about 2500 mN. In one embodiment, the films or a separator comprising the present films has a tear strength of from about 2000 mN to about 4000 mN. Tear strength can be evaluated using a Tear Strength tester, ATS-100, ATSFAAR Italy following ASTM D 1922.

In a lithium ion secondary battery, a cathode and an anode are laminated with a separator interposed therebetween, and the separator contains an electrolytic solution (electrolyte). Structure of the electrodes is not critical and may be a known structure. For example, the structure can be an electrode structure in which a cathode and an anode in the form of a disk are arranged opposed to each other (coin-type), an electrode structure in which a cathode and an anode in the form of a flat plate are alternately laminated (laminated-type), an electrode structure in which a cathode and an anode in the form of a strip are laminated and wound (wound-type), and the like.

The cathode typically has a current collector and a cathode active material layer that is formed on the surface of the current collector and contains a cathode active material capable of occluding and releasing lithium ions. Examples of cathode active materials include inorganic compounds such as transition metal oxides, composite oxides of lithium and a transition metal (lithium composite oxides), and transition metal sulfides, and examples of transition metals include V, Mn, Fe, Co, and Ni. Preferred examples of lithium composite oxides among the cathode active materials include lithium nickel oxide, lithium cobalt oxide, lithium manganese oxide, and layered lithium composite oxides based on α-NaFeO₂ structure.

The anode has a current collector and an anode active material layer that is formed on the surface of the current collector and contains an anode active material. Examples of anode active materials include carbonaceous materials such as natural graphite, artificial graphite, cokes, and carbon black. The electrolytic solution can be obtained by dissolving a lithium salt in an organic solvent. Examples of lithium salts include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, LiN(C₂F₅SO₂)₂, LiPF₄(CF₃)₂, LiPF₃(C₂F₅)₃, lower aliphatic carboxylic acid lithium salts, and LiAlCl₄. These may be used alone or in combination of two or more thereof. Examples of organic solvents include high-boiling and high-dielectric organic solvents such as ethylene carbonate, propylene carbonate, ethyl methyl carbonate, and γ-butyrolactone; and low-boiling and low-viscosity organic solvents such as tetrahydrofuran, 2-methyltetrahydrofuran, dimethoxyethane, dioxolane, dimethyl carbonate, and diethyl carbonate. These may be used alone or in combination of two or more thereof. In particular, high-dielectric organic solvents have high viscosity, and low-viscosity organic solvents have a low dielectric constant; therefore, it is preferable to use the two in combination.

When assembling a battery, the separator of the present invention is impregnated with an electrolytic solution. This provides the separator with ion permeability. In general, the impregnation treatment is performed by immersing a microporous porous membrane in an electrolytic solution at normal temperature. For example, in the case of assembling a cylindrical battery, a cathode sheet, a separator (composite porous membrane), and an anode sheet are first laminated in the order mentioned, and this laminate is taken up from one end to provide a wound-type electrode element. This electrode element is then inserted into a battery can and impregnated with the electrolytic solution described above, and, further, a battery lid that is provided with a safety valve and serves also as a cathode terminal is caulked via a gasket to thereby obtain a battery.

An electrochemical device employing the present films including, for example, a separator comprising the present films can operate in any suitable voltage range or current density as may be desired for a particular purpose or intended application. In one embodiment, the electrochemical device can operate in a range of from about 0.001 V to about 5.4 V, from about 0.01 V. to about 4.5 V, from about 0.5 to about 3.0 V, or from about 1 V to about 2.5 V. In one embodiment, the electrochemical device operates in a range of from about 0.01 V to about 3.0 V. In one embodiment, the electrochemical device employing the present films (such as a separator comprising the present films) operates at a current density of from about 50 mA/g to about 5 A/g, from about 100 mA/g to about 2.5 A/g, or from about 500 mA/g to about 1 A/g. In one embodiment, an electrochemical cell employing the present films (such as a separator comprising the present films) operates in a range of about 20 cycles to about 50 cycles at a current density of 100 mA/g, from about 25 to about 40 cycles at a current density of 100 mA/g, or from about 30 to about 35 cycles at a current density of 100 mA/g.

Aspects and embodiments of the present compositions, films formed from such compositions, components of electrochemical devices employing such films, and electrochemical devices employing such components may be further understood with respect to the following examples. The examples are not intended to be limiting but only to show examples of various aspects and embodiments of the present technology.

### EXAMPLES

Materials: Polypropelene (PP) was purchased from Indian oil corporation limited (IOCL), India. Polycarbonate (PC) was obtained from Markolon, Calif. Masterbatch (Pearlene™ SiPP MB01 Silicone) was obtained from Momentive Performance Materials, US.

Development of separator films: The films were extruded in twin screw extruder with definite thickness of about 25 μm. Initially the base polyolefin (polypropylene; polycarbonate) were compounded with the respective silicone masterbatch formulations in different weight ratios. The silicone masterbatch were taken in 5, 10, and 20 wt % with respect to the weight of the base polyolefin.

The compounding for polypropylene (PP) with masterbatch (Pearlene SiPP MB01 Silicone) was performed at 200° C. at a screw speed of 50 rpm. Polypropylene of two different melt flow indices (MFI) PP-MFI-6 and PP-MFI-11 were used for extrusion of the films of similar thickness. After cooling and maintaining the temperature of the compounded mixture for 24-48 hours, the mixture was then fed for extrusion. The temperature from the feed zone to die varied across 190-200° C. at the screw rate of 200 rpm and processed in machine direction. Finally, the films were allowed to set and retained for further analysis. In case of polycarbonate-based films, melt blending was done on Hakke Batch Mixer at a temperature of 270° C., and mixing RPM of 50 in 10 minutes. Subsequently, the Injection moulding for specimen preparation was performed at a temperature range of 250/260/270° C., with nozzle temperature of 260° C., and mould temperature of 60° C. at 100 rpm.

The separator film formulation details are provided in table 1 below.

TABLE 1
Different separator film formulations

| | Base | Melt flow indices | Wt % masterbatch |
|---|---|---|---|
| Formulation | polyolefin | (MFI) | loading (SiPPMB01) |
| 1 (control-1) | PP | 6 | 0 |
| 2 | PP | 6 | 5 |
| 3 | PP | 6 | 10 |
| 4 | PP | 6 | 20 |
| 5 (control-2) | PP | 11 | 0 |
| 6 | PP | 11 | 5 |
| 7 | PP | 11 | 10 |
| 8 | PP | 11 | 20 |
| 9 | PC | — | 1 |
| 10 | PC | — | 3 |
| 11 | PC | — | 5 |
| 12 | PC | — | 10 |
| 13 | PC | — | 20 |
| 14 (control-3) | PC | — | 0 |

### Example 1: Determination of Melt Flow Index of Various Formulations

Melt flow index (MFI) indicates the ease of flow of a thermoplastic polymer, which in turn affects its processability. The value of MFI is usually prescribed as g/10 min, indicating the amount of polymer (in grams) flowing across a capillary of a specific diameter under specific weight per 10 min. The unit is also expressed in kilograms and follows the standards of ASTM D1238 and ISO 1133. Polypropylene materials with different melt flow indices (MFI) (MFI of 6 and 11) were examined in order to understand the effect of MFI on compounding with silicone masterbatch and extrusion of energy device separator films. Subsequently their physicochemical characteristics have been examined.

### Example 2: Determination of Flammability of Various Formulations

### Method

The flammability test of the extruded films was performed on Horizontal Vertical Flame Chamber, ATLAS, HVUL-2, USA under the test standard of UL-94, which is one of the globally accepted standards for testing flammability of plastics for electrical and electronic applications. The tests results indicate the suitability of the material with respect to flammability in the application. The flammability is influenced by several factors such as ease of ignition, flame spread, fire endurance etc.

Per sample, three to five specimens were cut in the dimension of 5*12 inch², at a definite thickness and conditioned at 23° C. for 48 hours in a relative humidity of 50%. Specimens were mounted along their long axis vertical and supported such that the lower end of the specimen is ⅜′ above flame. Blue high flame is applied to the center of the lower edge of specimen and categorized as V-0, V-1 or V-2.

A specimen is characterized as V-0 when, burning time of each individual specimen after first and second flame application is less than 10 seconds and total burning time for ten flame application is less than 50 seconds. Also, in V-0, the burning and after glow of samples after second flame application is less than 30 seconds with no dripping of burning specimens and samples are completely burnt without any specimen left on the holding clamp.

In case of category V-1, burning time of each individual sample is less than 30 seconds after applying first and second flame, and the total burning time of ten samples is less than 250 seconds. The burning and after glow of samples after second flame application is less than 60 seconds and there is no dripping of the burning samples and no specimen left on the holding clamp.

In case of category V-2, burning time of each individual sample is less than 30 seconds after applying first and second flame, and the total burning time of ten samples is less than 250 seconds. The burning and after glow of samples after second flame application is less than 60 seconds and there is dripping of the burning samples and no specimen left on the holding clamp.

The flame which is applied to the center of the lower edge of specimen is called test flame. Typically, the test flame is applied for 10 seconds for each specimen. The time for burning the film specimen is denoted as t₁ for the first application of test flame and t₂ for the second application of test flame. In case the burning stops within 30 seconds, the flame is re-applied for another 10 seconds.

### Observations

The flammability of the separator films indicates their level of fire safety and resistance to spread of fire. The extruded films of polypropylene of MFI-6 and 11 mixed with silicone masterbatch were subjected to flame test as shown in table 3. It was observed that continuous burning occurred after first application of flame, after flame of all specimens up to the holding clamp observed. After flame time for each individual specimen t₁ was >30 s and the samples were not categorized under V-0, V-1 or V-2. The data for different separator film formulations are shown in Table 3 below. 5 different specimens for each formulation were used for flammability test. In case of formulation 14 (control-3) where the sample only contains PC without any silicone masterbatch, for each individual specimen t₁ or t₂ was <10 s and total burning time for all 5 specimens at any condition set (t₁+t₂ for the 5 specimens) was <50 s. In addition, any ignited particles of any specimen were not observed on the holding clamp with no dripping of samples. As all these characteristics fall under the category of V-0, so formulation 14 was characterized as V-0. The flammability of formulations 12 and 13 also showed characteristics of V-0. On the other hand, formulations 9, 10 and 11 showed (1, 3 and 5 wt % loading of masterbatch SiPCMB01) the flammability characteristics of V-2.

The flammability data also allows in grading the extruded films under categories of V-0, V-1 or V-2. The films based on PP when tested, did not fall under any category of V-0, V-1 or V-2. This may be due to the physicochemical properties of the extruded films. The flammability attributes displayed by the film of the present invention under the category of V-0, V-1 and V-2 indicates fire resistance attributes of the film. Such attributes are critical to the safety of films used in device components of an electrochemical cell.

TABLE 3
Flammability data for different separator film formulations

| | Vertical Burning | |
|---|---|---|
| Formulation | Observation | Results |
| 1 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2)After flame time for each | |
| | individual specimen t₁ was >30 s | |
| 2 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2)After flame time for each | |
| | individual specimen t₁ was >30 s | |
| 3 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2)After flame time for each | |
| | individual specimen t₁ was >30 s | |
| 4 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category |
| | 2)After flame time for each | |
| | individual specimen t₁ was >30 s | |
| 5 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category |
| | 2)After flame time for each | |
| | individual specimen t1 was >30 s | |
| 6 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2)After flame time for each | |
| | individual specimen t1 was >30 s | |
| 7 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2) After flame time for each | |
| | individual specimen t1 was >30 s | |
| 8 | 1) Continuous burning observed | Considering all above observation, it |
| | after first application of flame, | may be concluded that sample cannot |
| | after flame of all specimens up to | be classified as V-0, V-1 or V-2 |
| | the holding clamp observed. | category. |
| | 2)After flame time for each | |
| | individual specimen t1 was >30 s | |
| 9 | 1) After flame time for each | Considering all above observation, it |
| | individual specimen | may be concluded that sample can be |
| | t₁ or t₂ was <30 s | classified as V-2 category. |
| | 2) Total after flame time for any | |
| | condition set | |
| | (t₁ plus t₂ for the 5 specimens) | |
| | was <250 s | |
| | 3) Afterflame or afterglow of any specimen was | |
| | not observed up to the holding clamp | |
| | 4) Cotton indicator ignited by flaming practices | |
| | or drop | |
| 10 | 1) After flame time for each | Considering all above observation, it |
| | individual specimen | may be concluded that sample can be |
| | t₁ or t₂ was <30 s | classified as V-2 category. |
| | 2) Total after flame time for any | |
| | condition set | |
| | (t₁ plus t₂ for the 5 specimens) | |
| | was <250 s | |
| | 3) After flame or afterglow of | |
| | any specimen was | |
| | not observed up to the holding | |
| | clamp | |
| | 4) Cotton indicator ignited by | |
| | flaming practices | |
| | or drop | |
| 11 | 1) After flame time for each | Considering all above observation, it |
| | individual specimen | may be concluded that sample can be |
| | t₁ or t₂ was <30 s | classified as V-2 category. |
| | 2) Total after flame time for any | |
| | condition set | |
| | (t₁ plus t₂ for the 5 specimens) | |
| | was <250 s | |
| | 3) After flame or afterglow of | |
| | any specimen was | |
| | not observed up to the holding | |
| | clamp | |
| | 4) Cotton indicator ignited by | |
| | flaming practices | |
| | or drop | |
| 12 | 1) After flame time for each | Considering all above observation, it |
| | individual specimen | may be concluded that sample can be |
| | t₁ or t₂ was <10 s | classified as V-0 category. |
| | 2) Total after flame time for any | |
| | condition set | |
| | (t₁ plus t₂ for the 5 specimens) | |
| | was <50 s | |
| | 3) Afterflame or afterglow of any | |
| | specimen was | |
| | not observed up to the holding | |
| | clamp | |
| | 4) No dripping observed | |
| 13 | 1) After flame time for each | Considering all above observation, it |
| | individual specimen | may be concluded that sample can be |
| | t₁ or t₂ was <10 s | classified as V-0 category. |
| | 2) Total after flame time for any | |
| | condition set | |
| | (t₁ plus t₂ for the 5 specimens) | |
| | was <50 s | |
| | 3) After flame or after glow of | |
| | any specimen was not observed | |
| | up to the holding clamp | |
| | 4) No dripping observed. | |
| 14 | 1) After flame time for each | Considering all above observation, it |
| | individual specimen | may be concluded that sample can be |
| | t₁ or t₂ was <10 s | classified as V-0 category. |
| | 2) Total after flame time for any | |
| | condition set | |
| | (t₁ plus t₂ for the 5 specimens) | |
| | was <50 s | |
| | 3) After flame or afterglow of | |
| | any specimen was | |
| | not observed up to the holding | |
| | clamp | |
| | 4) No dripping observed. | |

### Example 3: Determination of Water Vapor Transmission (WVTR) of Various Formulations

### Method

The water vapor transmission was measured on Water Vapor permeability Tester, LYSSY, L80-5000, Switzerland following the standard of ASTM E96. Under this standard, the permeability of water vapor is analyzed through permeable and semi-permeable membranes. The test procedure includes the analysis of weight of a cup filled with distilled water with an air space of 0.75″ to 0.25″ between the membrane and water, which is subsequently sealed to restrict the loss of water vapor from elsewhere except through test specimen. Periodically the difference in weight of the cup is measured until a linear result is obtained. In order to perform this test, the specimens are cut in 4*4 inch.

### Observation

The control sample (formulation 1 containing only PP-MFI-6) shows a WVTR value of 3.42 g/m²·day, which was noted to increase with increase in silicone masterbatch loading, as shown in table 4 below. The maximum value of WVTR of 27.83 g/m²·day, was noted for PP-MFI-6 with 20 wt % SiPPMB01 (Formulation 4). The increase in water vapor transmission indicates a rise in permeability. Similarly, in case of control-2 (Formulation 5 with only PP-MFI-11) a WVTR of 3.52 g/m²·day was noted, which increases to 7.57 g/m²·day with 10 wt % SiPPMB01 loading (Formulation 7). The results suggested that an increase in water vapor transmission indicated a rise in permeability. The presence of silicone resin in the formulations increased the permeability of the film, which helps in transport of ions and molecules across the membrane in the energy device, which further helps in charging and discharging of the device. Such permeability supports the diffusion of gases which gets generated during the course of electrochemical reactions.

TABLE 4
Water Vapor permeability Tester data for
different separator film formulations

| Formulation | WVTR(g/m² · day) |
|---|---|
| 1 (control 1) | 3.42 |
| 2 | 10.21 |
| 3 | 18.81 |
| 4 | 27.83 |
| 5 (control 2) | 3.52 |
| 6 | 4.74 |
| 7 | 7.57 |

### Example 4: Determination of Tear Strength of Various Formulations

### Method

The tear test of the specimens was performed on Tear Strength tester, ATS-100, ATSFAAR Italy following ASTM D 1922, applying which the tearing resistance of plastic films can be determined. In this test, a pendulum impact tester is used to measure the force required to propagate a slit at a fixed distance from the edge of the test specimen. The specimens were cut from the extruded film and clamped on the tear tester. A slit was then created at an intended distance from the edge of the sample and the pendulum was allowed to propagate the slit through the remaining distance from the created slit.

### Observation

In case of PP-MFI-6 based formulations, the tear strength was noted to increase with increase in SiPPMB01 loading (Formulations 2-4) compared to the control sample (Formulation 1, without silicone masterbatch) as shown in Table 5. The flexible chains of silicone masterbatch provided flexibility in the silicone masterbatch added test formulations against tear.

TABLE 5
Tear test data for different separator film formulations

| Formulation | Tear Strength (mN) |
|---|---|
| 1 | 490 |
| 2 | 1050.3 |
| 3 | 2329.5 |
| 4 | 2694.7 |

Tear strength influences the performance of the device as a high tear strength film is helpful in flawless fabrication of device and provides high cycle life. In comparison to the control sample of formulation 1 (without silicone masterbatch), an increase in tear strength for formulations 2, 3 and 4 were noted. The improvement in tear strength suggested that the flexible chains of silicone masterbatch provide flexibility against tear. Such properties are generally beneficial in separators when applied in energy device, as it helped in resisting from tear during assembly of energy device as well during electrochemical working of the cell. The high tear resistance generally resists the propagation of any slit generation due to formation of unwanted solids/side reactions during electrochemical working of the cell.

### Example 5: Determination of Electrochemical Performance of Various Formulations

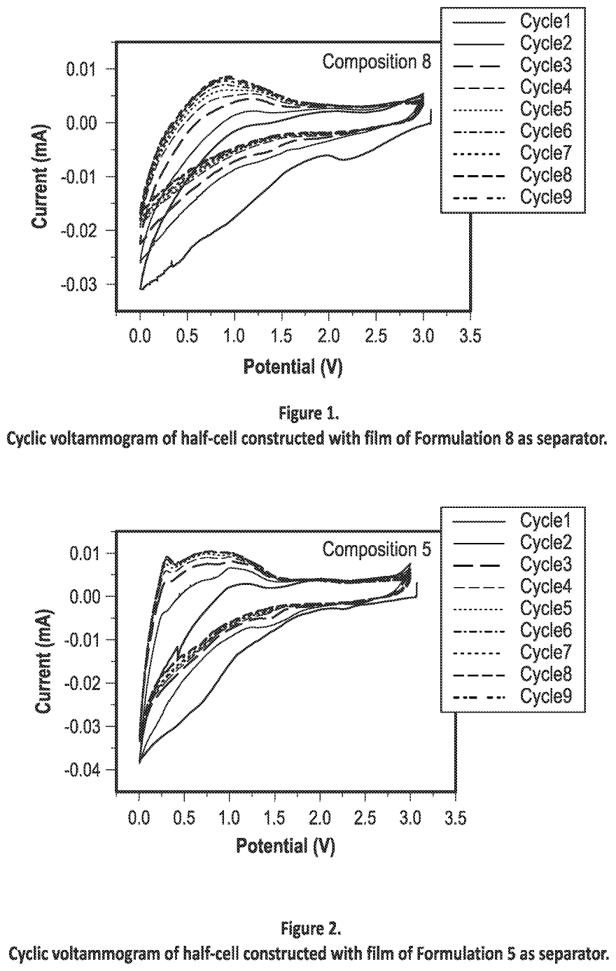

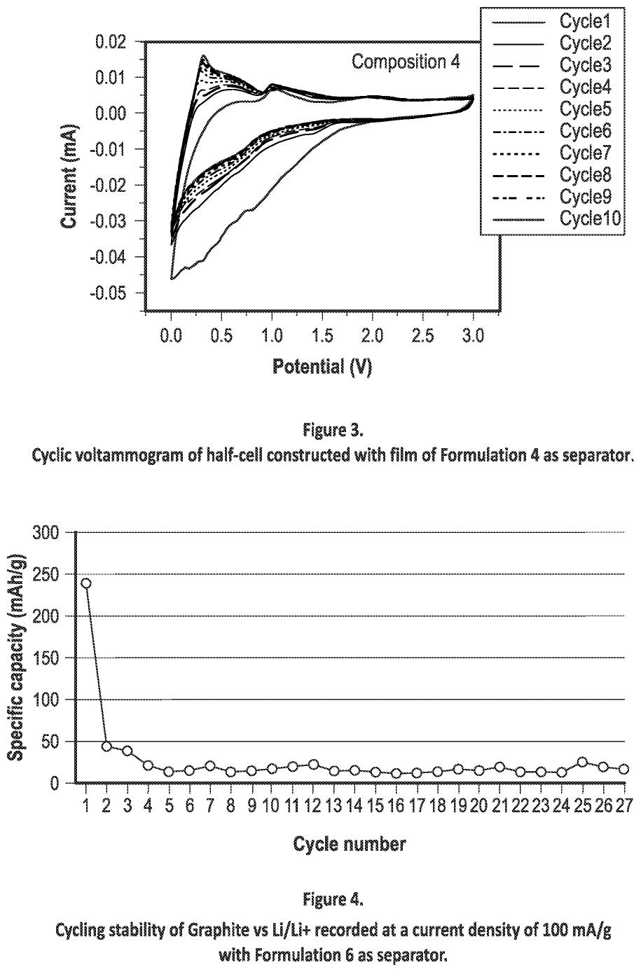

The cyclic voltammetry was performed to confirm the activity of extruded films as separators in lithium ion coin cells and the recorded voltammograms have been presented in FIGS. 1-3. The half-cell configurations were constructed by using graphite as cathode and cycled against elemental lithium foil between 3.0-0.01 V vs Li/Li⁺. The electrolyte composed LiPF₆/EC/EMC (1:1) and the cells were cycled 8-10 times at a scan rate of 0.2 mV/s.

### Construction of Cell

The cathode slurry comprised graphite, carbon black and PVDF binder in the ratio of 90:6:4 respectively. Graphite and PVDF were purchased from Sigma Aldrich and carbon black was procured from Thermo Fisher Scientific. All the chemicals were used as received. In order to achieve the slurry, a calculated amount of N-methyl pyrrolidone was used and then the slurry was coated over a copper foil. The coated copper foil was then dried in vacuum oven for 6 h at 70° C. After the drying, the vacuum oven was cooled to room temperature after which the copper foil was cut to obtain coins of 12 mm diameter. The separators were cut using a punch cutter of diameter 18 mm and the lithium foils used as anode were of 14 mm diameter. The 2032 type coin cells were constructed inside argon filled glove box with oxygen and moisture maintained below <0.1 ppm each and the CV was recorded on Biologic cell tester.

### Example 6. Determination of Dimensional Stability of the Extruded Films

The dimensional stability of the films was recorded by treating the films in hot air oven at specified temperature and duration. The temperatures were set at 80° and 150° C. individually in a hot air furnace, and separate set of samples of each formulation were placed in hot air oven for specified duration of 4 h at 80° C. and 10 min at 150° C. The samples were cut in rectangular shape and their size were measured before placing in the oven. The dimensional stability was calculated by checking the difference in dimension post exposure to heat and shown in Table 6.

TABLE 6
Dimensional stability of separator films
at different temperatures & duration

| | | | % | |
|---|---|---|---|---|
| | | | dimension | |
| | % dimension | Curling | retention at | Curling @ |
| | retention at | @ | 150° C./10 | 150° C./10 |
| Formulation | 80° C./4 h | 80° C./4 h | min | min |
| 1 | 100 | — | 100 | — |
| 2 | 100 | — | 100 | — |
| 3 | 100 | — | 100 | — |
| 4 | 100 | — | 100 | — |
| 5 | 100 | — | 100 | — |
| 6 | 100 | — | 100 | — |
| 7 | 100 | — | 100 | — |
| 8 | 100 | — | 100 | — |

### Observation

The cyclic voltammograms of the cells were recorded to evaluate the electrochemical properties at a scan rate of 0.2 mV/s between 0.01-3 V (vs Li⁺/Li) and presented in FIG. 1-3. During the first cathodic cycle, in FIG. 1. a peak appears at 2.3 V indicating the initiation of electrochemical reaction between the Li ions and the anode material. Further, a trough fall is seen over the lower voltage range visually 1-0.1 V, which can be attributed to the formation of solid electrolyte interface layer (SEI) during the first cathodic reaction at the electrode-electrolyte interface and irreversible capture of Li⁺ ions by graphite matrix. However, during the consecutive cathodic cycles, the cathodic peaks appeared stable and the trough appearing at lower voltages can be attributed to the insertion of lithium ions in the basal planes of the graphitic layers. Conversely, in the anodic cycles, peaks are observed at across 0.7-1.0 V in composition 8 due to the dilithiation from the graphite layer intermediates. Also, from the second cycle onwards, the CV curves remain stable indicating consistency in redox activity and shuttling of lithium ions across the electrodes. Similar observations have also been made in other compositions when applied as separator in lithium ion cell. These redox activity across the electrode is possible due to proper transfusion of lithium ion and molecules across the separator during the electrochemical cycling. In addition, the constant shuttling of lithium ions and molecules across the separator also indicate their robustness and stability in electrochemical environment over extended cycling of the cell. Subsequently the cycling stability of the cell was also performed for over 25 cycles at current density of 100 mA/g with formulation 6 as separator. This also suggests their dimensional stability in electrochemical environment, wherein the separator retains its shape and dimension restricting any short circuit between the electrodes.

The dimensional stability of energy device separator films safeguards the device from short circuit situation and protects the device from further hazards. To ascertain the robustness of the as extruded films, they were subjected to heat at different temperature and duration and simultaneously their dimensions and stability were noted. As noted from Table 6, the extruded films did not show any loss in dimension or curl when subjected to at 80° C./4 h or 150° C./10 min. All these observations indicated high stability of extruded films towards heat, which in turn is beneficial to maintain the safety of the energy device under operation. The high dimensional stability ensures the intactness of the film between the electrodes restricting the short circuit between anode and cathode even at elevated temperatures.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a composition comprising a thermoplastic resin and a silicone, articles comprising the compositions, devices employing the articles, and processes for forming the article. Modifications may occur to those skilled in the art and to those who may make and use the invention. The disclosed embodiments are merely for illustrative purposes and not intended to limit the scope of the invention or the subject matter set forth in the claims.

1. An electrochemical film composition comprising: (i) at least one thermoplastic resin, and (ii) a silicone-masterbatch, wherein the silicone-masterbatch comprises at least one silicone represented by formula (I):
MₐD_{b}T_{c}Q_{d}Rₑ (I)
where M is (R¹)(R²)(R³)SiZ_{1/2}
D is (R⁴)(R⁵)SiZ_{2/2}
T is (R⁶)SiZ_{3/2}
Q is SiZ_{4/2}
R¹, R², R³, R⁴, R⁵, and R⁶ are each independently selected from a C1-C10 alkyl, a C1-C10 alkoxy, a C2-C10 alkenyl, a C6-C20 aryl, OH, and a halogen atom; R is —(CH₂)_{1/2}(R⁷)_{f}(CH₂)_{1/2} where R⁷ is a C1-C10 alkyl; Z is independently selected from O, N, or S; a, b, c, d, and e are 0 or a positive integer where a+b+c+d+e is from about 1 to about 50,000, and f is 0 or 1.

2. The electrochemical film composition of claim 1, wherein the silicone is represented by formula (II):
MD_{b}M (II)
wherein M is (R¹)(R²)(R³)SiZ_{1/2} where R¹ and R² are each independently selected from a C1-C10 alkyl, and a C1-C10 alkoxy, and R³ is a C2-C10 alkenyl; D is (R⁴)(R⁵)SiZ_{2/2} where R⁴ and R⁵ are independently selected from a C1-C10 alkyl, and a C1-C10 alkoxy; Z is O; and b is about 100 to about 10,000.

3. The electrochemical film composition of claim 1, wherein the thermoplastic resin is represented by the formula (III):
[—C(R⁸)(R⁹)—C(R¹⁰)(R¹¹)—]_{z} (III)
where R⁸, R⁹, R¹⁰, and R¹¹ are each independently selected from H, a C1-C10 alkyl, a C1-C10 alkoxy, a C6-C20 aryl, and a halogen atom, and z is from about 10 to about 100,000.

4. The electrochemical film composition of claim 3, wherein R⁸, R⁹, R¹⁰, and R¹¹ are each H.

5. The electrochemical film composition of claim 4, wherein R⁸ and R¹⁰ are each H, and R⁹ and R¹¹ are each a C1-C10 alkyl.

6. The electrochemical film composition of claim 4, wherein the thermoplastic resin comprises polyolefin, polycarbonate, polyethylene terephthalate (PET), or their copolymers thereof, polyvinylcarbonate (PVC), polysulfone, styrene acrylonitrile, polyamide, or combinations thereof.

7. The electrochemical film composition of claim 1, wherein the thermoplastic resin is present in an amount of from about 1 wt. % to about 70 wt. %, and the silicone masterbatch is present in an amount of from about 1 wt. % to about 30 wt. % based on the total weight of the composition.

8. The electrochemical film composition of claim 1, wherein the composition further comprises a component selected from the group consisting of an acrylate, a methacrylate, a filler, a cross-linking agent, a pigment, a stabilizer, a dispersant, a wetting agent, a rheology modifier, a defoamer, a thickener, a biocide, a mildewcide, a colorant, and a co-solvent.

9. An electrochemical film comprising the composition of claim 1.

10. The film of claim 9, wherein the film has a porosity in the range from about 25% to about 50%.

11. The film of claim 9, wherein the film is a multilayered film comprising two or more layers where at least one of the layers comprises the electrochemical film composition.

12. The film of claim 11, wherein the multilayered film comprises a core layer, a first layer disposed on a first surface of the core layer, and a second layer disposed on a second surface of the core layer.

13. The film of claim 9 having a dimensional stability of about 50% to about 100% when subjected to a temperature in the range of 80-200° C. in air.

14. The film of claim 9, wherein the film has a retention in dimensional stability in the range from about 84% to about 100%, when subjected to a temperature of 200° C. for 3 min.

15. The film of claim 9, wherein the film is resistant to dimensional loss when heated at a temperature of 80° C. for 4 hours or at a temperature of 150° C. for 10 minutes.

16. The film of claim 9, wherein the film has a flammability in the range from about 0 to about 250 seconds as per UL94 standard.

17. The film of claim 9, wherein the film has a water vapour transmission rate (WVTR) in the range from about 1 g/m²·day to about 200 g/m²·day.

18. The film of claim 9, wherein the film has a tear strength in the range from about 200 mN to about 5000 mN in both machine and traverse directions.

19. An electrochemical separator comprising the film of claim 9.

20. An electrochemical device comprising the separator of claim 19.

21. The electrochemical device of claim 20, wherein the electrochemical device operates in a voltage range from about 0.001V to about 5.4 V.

22. The electrochemical device of claim 20, wherein the electrochemical device operates at current densities in the range from about 50 mA/g to about 5 A/g.

23. The electrochemical device of claim 20, wherein the electrochemical device operates for about 20 cycles to about 50 cycles at a current density of 100 mA/g.

24. A method of preparing an electrochemical film, the method comprising:
(a) extruding a composition of claim 1 to prepare a non-porous film; and
(b) stretching the non-porous film uniaxially or biaxially to allow developing a porosity in the range of from about 25% to about 50%.

25. An electrochemical film prepared by the method of claim 24 having a dimensional stability of about 50% to about 100% when heated at a temperature in the range of 80-200° C. in air
